(19) United States
(12) Patent Application Publication
(10) Pub. No.: US 2018/0126796 A1
(43) Pub. Date: May 10, 2018

(54) PNEUMATIC TIRE

(71) Applicant: TOYO TIRE & RUBBER CO., LTD., Itami-shi (JP)

(72) Inventor: Tsuyoshi Fujioka, Itami-shi (JP)

(73) Assignee: TOYO TIRE & RUBBER CO., LTD., Itami-shi (JP)

(21) Appl. No.: 15/685,415

(22) Filed: Aug. 24, 2017

(30) Foreign Application Priority Data
Nov. 9, 2016 (JP) 2016-219107

(51) Int. Cl. B60C 13/00; B60C 3/04; B60C 11/03

(52) U.S. Cl. CPC B60C 13/002; B60C 3/04; B60C 1/0025; B60C 2011/0337; B60C 11/03

(57) ABSTRACT

A pneumatic tire includes; a tread, portion; and a side portion formed continuously from the tread portion on a tire width direction side. The side portion includes: a projecting ridge extending in a tire circumferential direction; and projections arranged at predetermined intervals in the tire circumferential direction. The projections are formed such that a width of each projection is gradually narrowed toward the projecting ridge from a tire outer diameter side, and includes a distal end portion disposed inside of a region where the projecting ridge is positioned. A groove is formed between the projection and the projecting ridge.

### CROSS-REFERENCE TO RELATED APPLICATIONS

This application claims priority of Japanese Patent Application No.: 2016-219107 filed on Nov. 9, 2016, the content of which is incorporated herein by reference,

### BACKGROUND OF THE INVENTION

### Technical Field

The present invention relates to a pneumatic tire.

### Related Art

Conventionally, the following pneumatic tire has been known.

Japanese patent No. 3391692 discloses the configuration where extension blocks extending to a side wall portion are formed at intervals in a tire circumferential direction. Japanese patent No. 5066240 discloses the configuration where on an outer surface of a side wall portion, a plurality of protector ribs which are raised toward an outside in a tire axis direction and are inclined with respect to a tire radial direction are formed at intervals in a tire circumferential direction. Japanese patent No. 5893370 discloses the configuration where on an outer surface of a side wall portion on a more outside than a tire maximum cross-sectional width position in a radial direction, an annular region which extends over the whole circumference in a tire circumferential direction is formed, and a plurality of projections are formed in the annular region such that the projections are arranged side by side in a row in the circumferential direction.

### SUMMARY

However, none of these patent documents refers to a point for preventing the occurrence of damage to the side portion when a chain is mounted on the pneumatic tire.

It is an object of the present invention to provide a pneumatic tire which can sufficiently suppress the occurrence of damage to a side portion even when a chain is mounted on the pneumatic tire while enhancing traction performance.

According to an aspect of the present invention, the present invention provides, as a means for overcoming the above-mentioned drawbacks, a pneumatic tire which includes: a tread portion; and a side portion formed continuously from the tread portion on a tire width direction side, wherein
the side portion includes: a projecting ridge extending in a tire circumferential direction; and
projections arranged at predetermined intervals in the tire circumferential direction, the projections being formed such that a width of the projection is gradually narrowed toward the projecting ridge from a tire outer diameter side,
the projection includes a distal end portion disposed inside of a region where the projecting ridge is positioned, and a groove is formed between the projection and the projecting ridge.

With such a configuration, even when a chain is mounted on the pneumatic tire, the chain is brought into contact with the projecting ridge on the side portion and hence, the occurrence of a damage to the surface of the side portion can be prevented. Further, traction performance can be enhanced by the projections having a width gradually narrowed toward the projecting ridge. Still further, the projections can be formed within the region where the projecting ridge is formed in a separated state by the groove. With such a configuration, traction performance can be enhanced by increasing the number of traction elements and, at the same time, ability of discharging mud adhering to the pneumatic tire when the pneumatic tire travels on a muddy place can be enhanced.

It is preferable that a height of the projection from the surface of the side portion be greater than a height of the projecting ridge from the surface of the side portion.

With such a configuration, the occurrence of a damage to the surface of the side portion can be further effectively prevented due to the formation of the projections in addition to the projecting ridge. The traction performance can be further enhanced by increasing the number of traction elements due to the formation of such raised projections.

It is preferable that the projections be formed in an inclined manner with respect to a tire radial direction.

With such a configuration, traction performance can be further enhanced by increasing the number of traction elements during tire rolling.

It is preferable that the projections be inclined in the same direction with respect to the tire radial direction.

With such a configuration, traction performance during tire rolling can be made stable.

It is preferable that positions of the projections in the tire circumferential direction be made to agree with lug grooves formed on the tread portion.

With such a configuration, the surface of the side portion can be protected not only by the projecting ridge but also by the projections. Accordingly, even when a chain is mounted on the tire, the occurrence of being brought into contact with the surface of the side portion due to the chain can be prevented. Accordingly, it is possible to prevent the occurrence of damage to the surface of the side portion further efficiently.

It is preferable that a reinforcing protruding portion be formed between the projections disposed in the tire circumferential direction.

With such a configuration, rigidity of the side portion in the tire circumferential direction can be made uniform and hence, abnormal deformation when the tire is brought into contact with a ground can be suppressed whereby it is possible to prevent the occurrence of cracks caused by the abnormal deformation.

It is preferable that the positions of distal end portions of the respective projections be displaced from each other in a tire radial direction.

With such a configuration, a stepped portion is formed between the projections disposed adjacently in tire circumferential direction and hence, the tire can exhibit traction performance more easily.

The projection may be configured such that two sides extending from a distal end portion are inclined in the same direction with respect to a tire radial direction.

With such a configuration, mud can be easily discharged along the sides of the projection during traveling on a muddy place.

On the other hand, the projection may be configured such that two sides extending from a distal end portion are inclined in different directions with respect to a tire radial direction.

It is preferable that the projecting ridge may be formed within a range between an outer diameter side position which is far from a maximum tire width position by 40% of tire maximum height in tire outer diameter direction and an inner diameter side position which is far from the maximum tire width position by 40% of tire maximum height in tire inner diameter direction.

With such a configuration, a portion of the tire which is most strongly brought into contact with a chain mounted on the tire can be surely protected by the projecting ridge.

The projecting ridge may be formed of a plurality of projecting ridges formed separately from each other in the tire circumferential direction.

The projecting ridge may be divided in a tire radial direction so as to form a first projecting ridge positioned on the tire outer diameter side and a second projecting ridge positioned on a tire inner diameter side, and the distal end portion of the projection may overlap with the first projecting ridge.

According to the present invention, the projecting ridge is formed on the side portion and hence, even when a chain is mounted on the tire, the projecting ridge prevents the chain from being directly brought into contact with the side portion whereby the occurrence of damage on the side portion can be suppressed. Further, the projection is formed on the side portion and hence, traction performance can be enhanced by increasing the number of traction elements. Still further, the groove is formed between the projection and the projecting ridge and hence, traction performance can be enhanced by increasing the number of traction elements and, at the same time, ability of discharging mud adhering to the tire during traveling on a muddy place can be enhanced.

### BRIEF DESCRIPTION OF THE DRAWINGS

The foregoing and the other features of the present invention will become apparent from the following description and drawings of an illustrative embodiment of the invention in which:

FIG. 1 is a cross-sectional schematic view of a half of a pneumatic tire according to an embodiment of the present invention;

FIG. 2 is a developed front elevational view showing a tread portion and a portion of a side portion of the tire shown in FIG. 1 according to a first embodiment;

FIG. 3 is a developed front elevational view showing a tread portion and a portion of a side portion according to a second embodiment;

FIG. 4 is a developed front elevational view showing a tread portion and a portion of a side portion according to a third embodiment;

FIG. 5 is a developed front elevational view showing a tread portion and a portion of a side portion according to a fourth embodiment; and

FIG. 6 is a developed front elevational view showing a tread portion and a portion of a side portion according to a fifth embodiment.

### DETAILED DESCRIPTION OF EMBODIMENTS

Hereinafter, embodiments of the present invention are described with reference to attached drawings. In the description made hereinafter, although terms indicative of specific directions and positions (for example, terms including “up”, “down”, “side”, and “end”) are used when necessary, these terms are used for merely facilitating understanding of the invention with reference to drawings, and the technical scope of the present invention is not limited by meanings of these terms. Further, the description made hereinafter merely shows an example essentially, and does not intend to limit the present invention, products to which the present invention is applied, or its applications. Further, drawings are schematically shown and hence, ratios of respective sizes and the like may differ from actual ratios of sizes and the like.

### First Embodiment

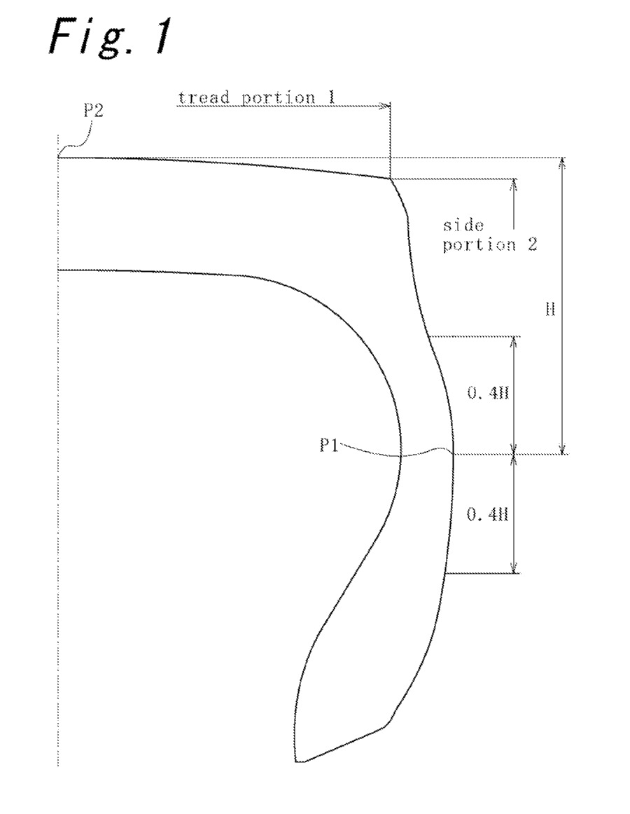

As shown in FIG. 1, a pneumatic tire according to a first embodiment includes a tread portion 1, and side portions 2 which are continuously formed with the tread portion 1 in a tire width direction.

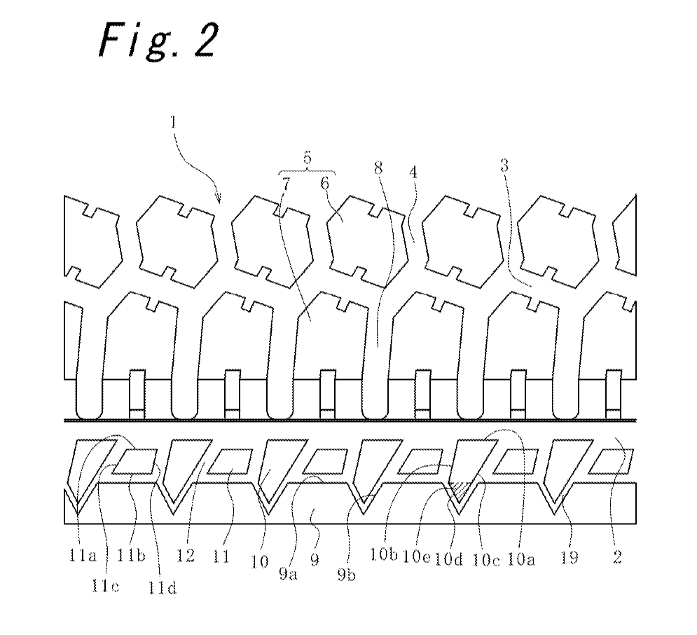

The tread portion 1 corresponds to a ground contact region in a state where the pneumatic tire is assembled to a normal rim and is filled with air of a normal internal pressure. FIG. 1 is a schematic cross-sectional view of the tire in a no-load state, and both side portions (only one side portion shown in FIG. 1) of the tread portion 1 are positioned on a lower side in the drawing. On the tread portion 1, as partially shown in FIG. 2, a plurality of blocks 5 are formed by main grooves 3 extending in a tire circumferential direction (in FIG. 2, in left and right directions) and lateral grooves 4 intersecting with the main grooves 3. In FIG. 2, blocks arranged in a row in the left and right directions on an upper side in FIG. 2 are mediate blocks 6 and blocks arranged in a row in left and right directions on a lower side in FIG. 2 are shoulder blocks 7. A lug groove 8 is formed between each two shoulder blocks 7 arranged adjacently to each other in left and right directions. Further, when a chain is mounted on the tire, portions of the chain are positioned in the lug grooves 8.

A maximum width position P1 at which a width of the tire becomes maximum is included in the side portion 2. A projecting ridge 9 and projections 10 described later are formed on the side portion 2. The projecting ridge 9 is a portion continuously formed in an annular shape in the tire circumferential direction, and is formed within a range of 40% of a reference height H in upward and downward directions with respect to the maximum width position P1. The reference height H means a distance in a tire radial direction from the maximum width position P1 to a center position P2 of the tread portion 1 in a state where the tire is at a normal internal pressure.

The projecting ridge 9 is a region projecting from a surface of the side portion 2 with a fixed height, and is continuously formed in an annular shape in the tire circumferential direction. V-shaped cutouts 9b are formed on an upper edge 9a of the projecting ridge 9 at a predetermined interval in the tire circumferential direction. By forming the projecting ridge 9 within a range of 40% of the reference height H in the upward and downward directions with respect to the maximum width position P1, it is possible to prevent portions of a chain from being brought into direct contact with the surface of the side portion 2 when the chain is mounted on the tire.

The projection 10 is formed into a chevron shape which is inclined toward one side in the tire circumferential direction (to be more exact, not a chevron shape but a rectangular shape with a width gradually narrowed toward a lower end). To be more specific, from both ends of an upper side 10a which extends in the tire circumferential direction on a tire outer diameter side, both sides (a left side 10b and a right side 10c) extend toward a tire inner diameter side (downward) in a state where both sides gradually approach to each other. In this embodiment, the left side 10b and the right side 10c are inclined in the same direction with respect to the tire radial direction. That is, both the left side 10b and the right side 10c extend in a direction from an upper right side to a lower left side with respect to the tire radial direction. Lower ends of both sides 10b, 10c are connected to each other by a lower side 10d which extends obliquely rightward and downward. The projection 10 is formed toward the projecting ridge 9 from a region of the side portion 2 on a more tread portion side than a region of the side portion 2 where the projecting ridge 9 is formed (also referred to as a buttress portion). A distal end portion 10e of the projection 10 is positioned in the cutout 9b of the projecting ridge 9, and a narrow groove 19 is formed in a boundary portion between the distal end portion 10e and the projecting ridge 9. By forming the narrow groove 19, the projection 10 can be separated from the projecting ridge 9 so that the number of traction elements can be increased thus enhancing traction performance. In this embodiment, the traction element means an edge component in the tire radial direction. By forming the narrow groove 19, it is expected that the tire can enhance its ability of discharging mud adhering to the tire when the tire travels on a muddy place. A projecting size of the projection 10 from the surface of the side portion 2 is greater than a projecting size of the projecting ridge 9 from the surface of the side portion 2. A traction performance is enhanced also in this respect. That is, the projection 10 having a large projection size is easily entangled with mud in a muddy place or the like and hence, a traction performance is enhanced. The projection 10 is arranged in the same tire radial direction as the lug groove 8. Accordingly, in a state where a chain (not shown in the drawing) is mounted on the tire, the chain is brought into contact with the projection 10, and the occurrence of being brought into contact with the surface of the side portion 2 due to the chain can be prevented.

A reinforcing protruding portion 11 is formed between each two projections 10 disposed adjacently to each other in the tire circumferential direction. The reinforcing protruding portion 11 has a trapezoidal shape, and an upper side 11a and a lower side 11b are formed parallel to the upper edge 9a of the projecting ridge 9. A left side 11c of each reinforcing protruding portion 11 is formed parallel to a right side 10c of the projection 10 disposed on the left side of each reinforcing protruding portion 11, and a right side 11d of each reinforcing protruding portion 11 is formed parallel to the left side 10b of the projection 10 disposed on the right side of the reinforcing protruding portion 11. With such a configuration, a groove portion 12 having a predetermined distance is formed between the projection 10 and the reinforcing protruding portion 11. A height of the reinforcing protruding portion 11 from the surface of the side portion 2 is substantially equal to a height of the projecting ridge 9 from the surface of the side portion 2. By forming the reinforcing protruding portion 11 between the projections 10, it is possible to suppress that rigidity of the side portion 2 becomes non-uniform in the tire circumferential direction due to the formation of the projections 10. That is, rigidity of the side portion 2 in the tire circumferential direction which becomes non-uniform due to the formation of the projections 10 can be corrected by forming the reinforcing protruding portions 11 so that the occurrence of cracks caused by the abnormal deformation when the pneumatic tire is brought into contact with a ground can be prevented.

According to the pneumatic tire having the above-mentioned configuration, the following advantageous effects can be acquired.

(1) The projecting ridge 9 extending in the tire circumferential direction is formed within a predetermined region of the side portion 2 and hence, when a chain is mounted on the tire, it is possible to prevent the chain from being brought into direct contact with the side portion 2 by the projecting ridge 9. With such a configuration, the side portion 2 is not likely to be damaged by the chain.
(2) The plurality of projections 10 are formed on the side portion 2 at a predetermined interval in the tire circumferential direction and hence, the side portion 2, particularly, the buttress portion can be protected. Further, the number of traction elements can be increased by the projections 10 and hence, the traction performance of the tire can be enhanced. Particularly, the projections 10 are formed separately from the projecting ridge 9 by forming the narrow grooves 19 and hence, the traction performance can be enhanced. Further, due to the inclination of the projection 10, the mud discharging ability of the pneumatic tire when the pneumatic tire travels on a muddy place can be enhanced.
(3) The reinforcing protruding portion 11 is formed between the projections 10 and hence, variations in rigidity of the side portion 2 in the tire circumferential direction due to the formation of the projections 10 can be suppressed. Accordingly, it is possible to prolong the life of the tire even though the projections 10 are formed.

### Second Embodiment

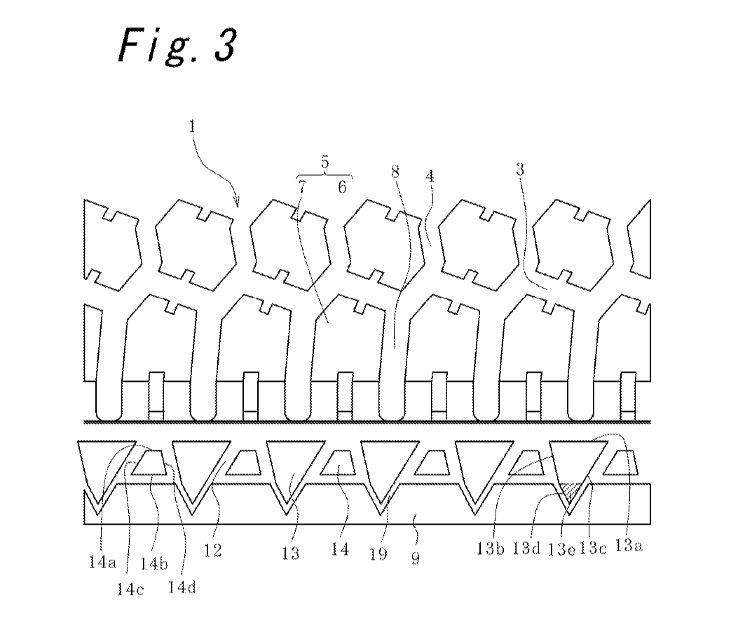

As shown in FIG. 3, a second embodiment differs from the first embodiment merely with respect to the shape of a projection 13 and the shape of a reinforcing protruding portion 14, and has the same configuration as the first embodiment with respect to other portions. Accordingly, parts of the second embodiment corresponding to the parts of the first embodiment are given the same symbols, and the description of these parts is omitted.

Although a height of the projection 13 from a surface of a side portion 2 in the second embodiment is equal to the height of the projection 10 from the surface of the side portion 2 in the first embodiment, the projection 13 differs from the projection 10 with respect to a point that an inclination direction of a left side 13b of the projection 13 is opposite to an inclination direction of a right side 13c of the projection 13 with respect to the tire radial direction. That is, the left side 13b is inclined such that the left side 13b extends from a left upper side to a right lower side. With such a configuration, an area which the projections 13 occupy on the side portion 2 is increased. As a result, in a state where a chain is mounted on the tire, it is possible to prevent the chain from being brought into contact with a surface of the side portion 2 with more certainly.

The reinforcing protruding portion 14 has a trapezoidal shape, and a left side 14c of each reinforcing protruding portion 14 is formed parallel to a right side 13c of the projection 13 disposed on the left side of each reinforcing protruding portion 14, and a right side 14d of each reinforcing protruding portion 14 is formed parallel to a left side 13b of the projection 13 disposed on the right side of each reinforcing protruding portion 14. An upper side 14a and a lower side 14b are parallel to each other in the tire circumferential direction. Although an area which the reinforcing protruding portions 14 of the second embodiment occupy is smaller than an area which the reinforcing protruding portions 11 of the first embodiment occupy, rigidity balance in the tire circumferential direction can be made uniform thus preventing the occurrence of cracks caused by abnormal deformation when the pneumatic tire is brought into contact with a ground.

### Third Embodiment

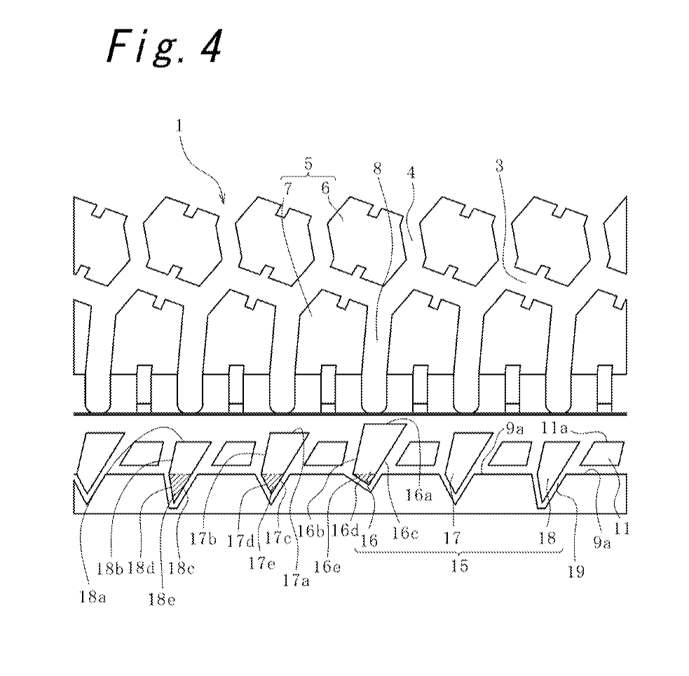

As shown in FIG. 4, a third embodiment differs from the first embodiment merely with respect to a shape of a projection 15, and has the same configuration as the first embodiment with respect to other portions. Accordingly, parts of the third embodiment corresponding to the parts of the first embodiment are given the same symbols, and the description of these parts is omitted.

The projections 15 are formed of first projections 16, second projections 17, and third projections 18. The first projection 16, the second projection 17, and the third projection 18 differ from each other with respect to a position of upper sides 16a, 17a, 18a in the tire radial direction and inclination angles of a lower side 16d, 17d, 18d in the tire radial direction.

The first projection 16 is configured such that the position of the upper side 16a is disposed remotest from an upper edge 9a of a projecting ridge 9 compared to the upper sides 17a, 18b of the second and third projections 17, 18. Further, a lower side 16d of the first projection 16 has a largest inclination angle with respect to the tire radial direction compared to the lower sides 17d, 18d of the second and third projections 17, 18. Accordingly, the position of a lower end of the first projection 16 is disposed closest to the upper edge 9a of the projecting ridge 9 compared to the positions of lower ends of the second and third projections 17, 18 so that a distal end portion 16e which bites into the projecting ridge 9 has a smallest area compared to distal end portions 17e, 18e.

The third projection 18 is configured such that the position of an upper side 18a is disposed closest to the upper edge 9a of the projecting ridge 9 compared to upper sides 16a, 17a of the first and second projections 16, 17, and the position of the upper side 18a is made to agree with the position of an upper side 11a of the reinforcing protruding portion 11 in the tire radial direction. Further, a lower side 18d of the third projection 18 has a smallest inclination angle with respect to the tire radial direction compared to inclination angles of lower sides 16d, 17d of the first and second projections 16, 17. Accordingly, the position of a lower end of the third projection 18 is disposed remotest from the upper edge 9a of the projecting ridge 9 compared to the positions of lower ends of the first and second projections 16, 17, and a distal end portion 18e which bites into the projecting ridge 9 has a largest area compared to distal end portions 16e, 17e of the first and second projections 16, 17.

The second projection 17 is configured such that the position of the upper side 17a with respect to the upper edge 9a of the projecting ridge 9 is disposed between the upper side 16a of the first projection 16 and the upper side 18a of the third projection 18. Further, an inclination angle of the lower side 17d of the second projection 17 is also between an inclination angle of the lower side 16d of the first projection 16 and an inclination angle of the lower side 18d of the third projection 18. Still, further, an area of the distal, end portion 17e which bites into the projecting ridge 9 is also between an area of the distal end portion 16e of the first projection 16 and an area of the distal end portion 18e of the third projection 18.

A left side 16b of the first projection 16, a left side 17b of the second projection 17, and a left side 18b of the third projection 18 are inclined at the same angle and in the same direction as the left side 10b of the projection 10 of the first embodiment. A right side 16c of the first projection 16, a right side 17c of the second projection 17, and a right side 18c of the third projection 18 are also inclined at the same angle and in the same direction as the right side 10c of the projection 10 of the first embodiment.

The first projection 16, the second projection 17 and the third projection 18 are disposed in this order such that the second projection 17 is disposed on the right side of the first projection 16 in the tire circumferential direction, and the third projection 18 is disposed on the right side of the second projection 17.

As described above, the projections 15 are formed of three kinds of projections which are positionally displaced from each other in the tire radial direction and hence, it is possible to obtain an advantageous effect that the tire can exhibit further traction performance.

In the third embodiment, the projections 15 are formed of three kinds of projections which are positionally displaced from each other in the tire radial direction. However, the projections 15 may be formed of two kinds or four or more kinds of projections. Further, although the lower sides 16d, 17d, 18d are inclined at different inclination angles respectively, projections 15 having the same shape may be merely positionally displaced from each other in the tire radial direction.

### Fourth Embodiment

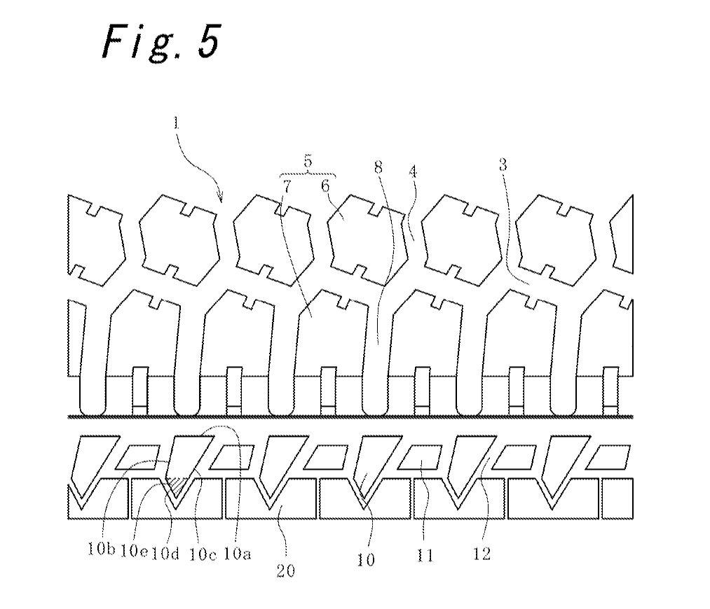

As shown in FIG. 5, in a fourth embodiment, instead of forming a projecting ridge 9 by one protruding portion continuously formed in the tire circumferential direction, the projecting ridge 9 is formed of a plurality of protruding portions 20 which are arranged in a row in the tire circumferential direction. A distance between the protruding portions 20 is narrowed thus preventing a chain from being brought into direct contact with a surface of a side portion. The protruding portions 20 are formed such that one protruding portion 20 corresponds to one projection 10. Since the projecting ridge 9 is formed of the plurality of protruding portions 20, the tire can acquire both of an advantageous effect that traction performance in the radial direction can be enhanced and an advantageous effect that mud discharging ability can be enhanced. In this embodiment, the protruding portions 20 are formed such that one protruding portion 20 corresponds to one projection 10. However, the protruding portions 20 may be formed such that one protruding portion 20 corresponds to two or more projections 10.

### Fifth Embodiment

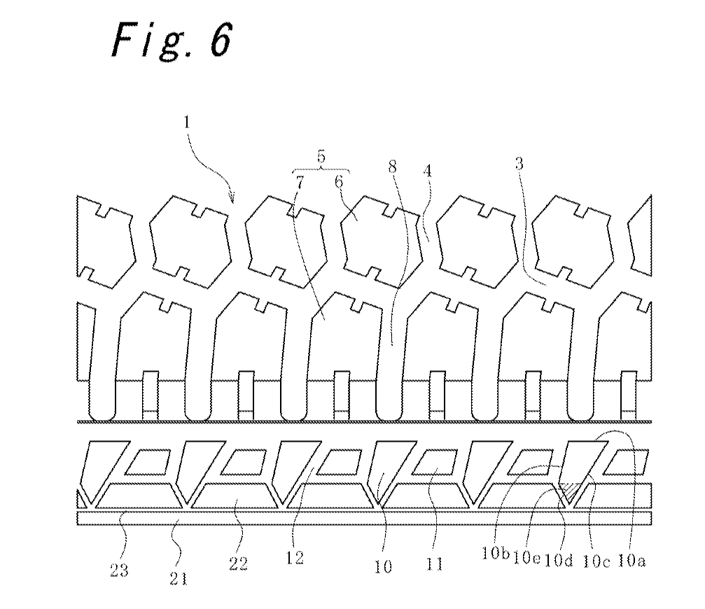

As shown in FIG. 6, in a fifth embodiment, instead of forming a projecting ridge 9 by one projecting ridge continuously formed in the tire circumferential direction, the projecting ridge 9 is formed of two projecting ridges, that is, a first projecting ridge 21 and a second projecting ridge 22.

The first projecting ridge 21 is disposed inside the second projecting ridge 22 in the tire radial direction, and a narrow groove 23 extending in the tire circumferential direction is formed between the first projecting ridge 21 and the second projecting ridge 22. Distal end portions 10e of projections 10 are positioned in the second projecting ridge 22. Since a width of the second projecting ridge 22 cannot be sufficiently ensured, the second projecting ridge 22 is cut on a distal end side of the projections 10 so that the second projecting ridge 22 is divided in the tire circumferential direction.

In this manner, the projecting ridge 9 is formed of: the second projecting ridge 22 with which the distal end portions of the projections 10 overlap; and the first projecting ridge 21 which is completely separated from the second projecting ridge 22. Accordingly, rigidity of the second projecting ridge 22 which overlaps with the projection 10 can be suppressed and hence, when the tread portion 1 is brought into contact with a ground, a side portion 2 can be easily deformed. With such a configuration, the tire can enhance traction performance while ensuring riding comfort. Further, the side portion 2 can be reinforced by the first projecting ridge 21, and it is possible to prevent a chain from being brought into direct contact with the surface of the side portion 2 in cooperation with the second projecting ridge 22.

What is claimed is:

1. A pneumatic tire comprising:
a tread portion; and
a side portion formed continuously from the tread portion on a tire width direction side, wherein
the side portion includes: a projecting ridge extending in a tire circumferential direction; and
projections arranged at predetermined intervals in the tire circumferential direction, the projections being formed such that a width of each projection is gradually narrowed toward the projecting ridge from a tire outer diameter side,
each of the projections includes a distal end portion disposed inside of a region where the projecting ridge is positioned, and a groove is formed between the projection and the projecting ridge.

2. The pneumatic tire according to claim 1, wherein a height of the projection from a surface of the side portion is greater than a height of the projecting ridge from the surface of the side portion.

3. The pneumatic tire according to claim 1, wherein the projections are formed in an inclined manner with respect to a tire radial direction.

4. The pneumatic tire according to claim 3, wherein the projections are inclined in the same direction with respect to the tire radial direction.

5. The pneumatic tire according to claim 1, wherein positions of the projections in the tire circumferential direction are made to agree with lug grooves formed on the tread portion.

6. The pneumatic tire according to claim 1, wherein a reinforcing protruding portion is formed between the projections disposed in the tire circumferential direction.

7. The pneumatic tire according to claim 1, wherein the positions of distal end portions of the respective projections are displaced from each other in a tire radial direction.

8. The pneumatic tire according to claim 1, wherein the projection is configured such that two inclined sides extending from a distal end are inclined in the same direction with respect to a tire radial direction.

9. The pneumatic tire according to claim 1, wherein the projection is configured such that two inclined sides extending from a distal end are inclined in different directions with respect to a tire radial direction.

10. The pneumatic tire according to claim 1, wherein the projecting ridge is formed within a range between an outer diameter side position which is far from a maximum tire width position by 40% of tire maximum height in tire outer diameter direction and an inner diameter side position which is far from the maximum tire width position by 40% of tire maximum height in tire inner diameter direction.

11. The pneumatic tire according to claim 1, wherein the projecting ridge is formed of a plurality of projecting ridges formed separately from each other in the tire circumferential direction.

12. The pneumatic tire according to claim 1, wherein the projecting ridge is divided in a tire radial direction so as to form a first projecting ridge positioned on the tire outer diameter side and a second projecting ridge positioned on a tire inner diameter side, and the distal end portion of the projection is configured to overlap with the first projecting ridge.
